(19) United States
(12) Patent Application Publication
(10) Pub. No.: US 2026/0225161 A1
(43) Pub. Date: Aug. 6, 2026

(54) WEAR RESISTANT DIAMOND BRAZE MATERIAL

(71) Applicant: Inland Diamond Products Co., Madison Heights, MI (US)

(72) Inventor: Ronald C. WIAND, Troy, MI (US)

(21) Appl. No.: 19/530,635

(22) Filed: Feb. 5, 2026

Related U.S. Application Data
(60) Provisional application No. 63/754,294, filed on Feb. 5, 2025.

(51) Int. Cl. B23B 27/14; B23B 27/20

(52) U.S. Cl. CPC B23B 27/148; B23B 27/20; B23B 2226/31; B23B 2240/08

(57) ABSTRACT

A diamond grinding, cutting, or drilling tool and process which includes at least a monolayer of a diamond or diamond-like hardness material and a wear resistant diamond braze material. A primary grinding sized grit affixed to a surface of said grinding, cutting or drilling tool by a flowable braze material capable of wetting and bonding to primary sized grit of carbon containing diamond or diamond-like hardness material and wherein said flowable brazing material contains a secondary protective sized diamond or diamond-like hardness grit material which protects the flowable braze material during grinding with the diamond grinding, cutting and/or drilling tool.

### CROSS-REFERENCE TO RELATED APPLICATIONS

This application claims the benefit of U.S. Provisional Application No. 63/754,294, filed on Feb. 5, 2025. The entire disclosures of each of the above applications are incorporated herein by reference.

### FIELD OF THE INVENTION

The present invention relates to a wear resistant diamond braze material.

### BACKGROUND OF THE INVENTION

The applicant Ronald C. Wiand and Inland Diamond Products Company has been a pioneer in diamond cutting and grinding tools and methods for ophthalmic grinding of lenses, glass, ceramics, marble and granite refinishing and the like. Many advances in cutting tools have been designed, manufactured and used in the industry. One of the greatest advances in these grinding and cutting tools and methods is providing robust attachments to underlying tools for grit materials used. Mr. Wiand has pioneered brazing of diamond patents in his U.S. Pat. Nos. 4,776,862 and 4,968,326. These brazes and methods are used in tools wherein monolayers of diamonds or diamond-like hardness grit materials or having primarily the same grit size to produce very robust abrasive materials which were longer lasting than past structures used.

However, even with these advances in brazing materials for securely attaching diamond hardness grit materials, use of the grinding and cutting tools on workpieces eventually will deteriorate or overcome the braze materials and the bonds to the grit materials which eventually requires repair or replacement of the grinding tool or the grit surface.

Therefore, in advancing the grinding and cutting tool technology it has always been a goal in the art to provide an even longer lasting abrasive structure than that which has been available in the past.

### SUMMARY OF THE INVENTION

A diamond grinding, cutting, or drilling tool and process which includes at least a monolayer of a primary diamond or diamond-like hardness material and a wear resistant diamond braze material. A first primary grinding sized grit affixed to a surface of said grinding, cutting or drilling tool by a flowable braze material capable of wetting and bonding to the first grinding sized grit of carbon containing diamond or diamond-like hardness material and wherein said flowable brazing material contains a second protecting sized diamond or diamond-like hardness grit material which protects the flowable braze material during grinding with the diamond grinding, cutting and/or drilling tool. Typically, the second protecting size grit is at least a grit size smaller than the primary sized grit.

The present invention is suitable for use on friction materials also. Friction materials of the present invention can be used and or applied in applications such as brake discs, chisel materials, granite wheels, drills, granite drills, ductile iron, sewer pipes and meter pipes. The wheels provide grinding results with at least 20% longer life when tested in grinding of a cast iron substrate.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a cross-sectional view showing the “green” state of a tool incorporating a primary abrasive grit and an effective amount of secondary protecting abrasive grit material prepared in accordance with the teachings of the present invention;

FIG. 2 is a sectional view illustrating the progression of the braze incorporating a primary abrasive grit and an effective amount of secondary protecting abrasive grit material during the heating step;

FIG. 3 is a sectional view of a diamond particle after it is partially worn away and the braze incorporating a primary abrasive grit and an effective amount of secondary protecting abrasive grit material actively protects the braze from breaking down further protecting the remaining bond with the primary diamond grit particles increasing the abrasive tool functional life; and

FIG. 4 is a sectional view of the primary cutting diamond grit material in a monolayer structure being protected from wear via the braze material incorporating an effective amount of braze protecting abrasive grit material of the present invention.

### DETAILED DESCRIPTION OF THE PREFERRED EMBODIMENTS

The following description of the preferred embodiment(s) is merely exemplary in nature and is in no way intended to limit the invention, its application, or uses.

A diamond grinding, cutting, or drilling tool which includes at least a monolayer of a primary diamond or diamond-like hardness material and a wear resistant diamond braze material. A first primary grinding sized grit affixed to a surface of said grinding, cutting or drilling tool by a flowable braze material capable of wetting and bonding to the first grinding sized grit of carbon containing diamond or diamond-like hardness material and wherein said flowable brazing material contains a secondary filler sized diamond or diamond-like hardness grit material which protects the primary diamond grit bond with the flowable braze material during grinding with the diamond grinding, cutting and/or drilling tool. The abrasive grit material 16 is preferably comprised of a diamond or diamond-like hardness abrasive grit. Preferably, diamond-like hardness abrasive grits such as tungsten carbide, cubic boron nitrite, and diamond grit particles are utilized in the present invention. However, other materials such as silicon carbides, tungsten carbides, oxides, garnets, cubic boron nitride, and natural and synthetic diamonds may be used alone or in combination in the present invention. In the present invention the primary grinding sized carbon containing diamond or diamond-like hardness material is of a size useful in a grinding, cutting and/or drilling tool Typically these particles are the size which is effective for the final grinding job at hand. Thus, the primary grinding sized grit is selected to be the exact grit desired for the grinding or polishing job that the tool is to be used for. Typically, the primary abrasive grit has a first size of not greater than about 1500 microns in size.

The secondary protection sized grit is preferably diamond or diamond-like hardness material which is at least a grit size smaller and typically at least 10% smaller size grit than said first size. With preferred effective secondary protection sized grits being from about 10% to 50% smaller in size than the primary grit. Secondary protection sized grits are preferably the same or at least as hard as the primary abrasive grit material to be the most effective. Thus, the secondary protection sized grit is typically the same material as the primary abrasive grit. Typically, the second protecting size grit is at least a grit size smaller than the primary sized grit. Diamond-like hardness abrasive grits such as tungsten carbide, cubic boron nitrite, and diamond grit particles are utilized as the secondary protection abrasive grit in the present invention. The secondary grit is smaller such that the surface finish provided by the primary grit size will be maintained in the grinding operation at all times but the finer smaller sized secondary grit will begin armoring or protecting the braze and slow down further erosion of the primary particles as the primary grit gets worn away and the secondary grit interacts with the surface which is being ground or worked on with the abrasive tool. Additionally, the secondary grit provides armoring or protection against erosion of the braze bonding material itself which protects the bond between the primary grit and the braze material. Thus, the life of the grinding tool is substantially enhanced due to the addition of the secondary protecting grit material. Generally, the amount secondary protecting grit is used in the braze in amounts of about 0.1% to about 60% by weight of the braze material but it is typically used in amounts of from 7-12% by weight and an amount of less than or equal to about 10% by weight of the braze material. The secondary protecting sized grit has a grit size from generally about ⅘ microns to about 500 microns, using from about 0.5% to 5.0% by weight typically from about 45 microns to about 350 microns using from about 1.0% to 4.0 and preferably from about 74 microns to about 149 using 2.0% to 3.0 % by weight.

The secondary protection sized grit particles are used in amounts of generally from about 0.01 to about 10.0 percent typically from about 0.1 to about 9.0 percent and preferably from about 1.0 to about 7.0 percent by weight. Because there are so many more particles of diamond per carat in the finer particle sizes, less diamond weight is required. Some examples: 46 microns size diamond has 1,820,000 particles per carat weight (1.0 carat=0.200 grams), 107 microns size diamond has 135,100 particles per carat and 501 microns size diamond has 1,240 particles per carat.

The wear of the primary brazed diamond grit material is substantially increased by use of the present invention. The articles and process of the present invention is useful for improving the life of cutting tools, grinding tools and finishing tools used in the ophthalmic lens industry. However, the teachings of the present invention are also useful for improving the longevity of friction materials such as those used in brake discs or clutch discs. The teaching are also useful in drills and grinding wheels used for working granite materials and in grinding and cutting fiberglass and tools used in grinding and cutting ductile iron sewer pipes or water pipes.

By way of further explanation, the types of brazes used and methods of making the protected primary grit tools in accordance with the teachings of the present invention is set forth below.

Referring to the drawings, in accordance with the first step of the present invention, a mixture of a carbide forming substance 10, a brazing material 12, a primary larger sized cutting grit 14, temporary binder 18 and a second filler sized protective diamond-like hardness abrasive grit 20 is prepared and thereafter applied to a tool substrate 16. The carbide forming substance preferably includes a metal which will form a metal carbide layer on the diamond particles during the heating step. Suitable carbide forming metals are well known in the art and include, for example, iron, molybdenum, chromium, tantalum, titanium, zirconium, tungsten, niobium, vanadium, manganese, germanium and silicon, and mixtures thereof. It will be appreciated that such carbide forming metals can be used in the form of their carbide forming compounds such as molybdenum silicide or tungsten carbide, the free metal of which can form carbides. Iron, chromium, and molybdenum are preferred metals and may be used singly or in combination. In the preferred embodiment from about 2.0 to about 30% of the carbide of forming substance is mixed with or alloyed into 20% to 80% braze.

The temporary binder selected must be temporary in that it is easily driven off in the heating step but allows temporary suspension of the carbide forming substance component and the brazing material component of the coating. It is preferable that the binder is somewhat viscous such that the above components may be easily suspended. It is also preferable that the binder utilized will be somewhat tacky such that the diamond particles are retained on the tool surface coated with the above mixture. A preferred binder is a urethane-based adhesive, such as a Wall Colmonoy “S” type binder. Other suitable binders include acrylic resins, methyl methacrylate resins, fish protein, lacquers, paints and the like. The binder used also must be relatively inert in that it must not adversely affect the components in the final heating step.

The braze material selected is chosen to be compatible with the particular carbide forming metal utilized in the carbide forming substance, i.e., to alloy with the carbide forming metal. Suitable brazes include nickel, silver, gold, or copper based brazes. Suitable brazes are commercially available, for example, from Wall Colmonoy Corporation of Detroit, Michigan under the Nicrobraze® line.

As shown in FIG. 4 during wear of the diamond tool the portion 24 is worn down during contact with the work piece. However, when the secondary filler sized protective diamond particles 20 are reached at level 22 the wearing of the cutting diamonds stabilizes and is substantially diminished because of the particles 20 protecting the braze material.

In accordance with the second step of the present invention, the mixture of carbide forming substance, braze material and binder is coated onto the desired surface of tool substrate 16 in a somewhat uniform layer. This may be accomplished by brushing, spraying or dipping of the surface of the tool 16 in the mixture. While this layer is still tacky, a monolayer of diamond particles 14 is applied to the tacky layer. The diamond particles 14 may be applied either singly by hand application or could be applied by sprinkling of diamond particles onto the tool.

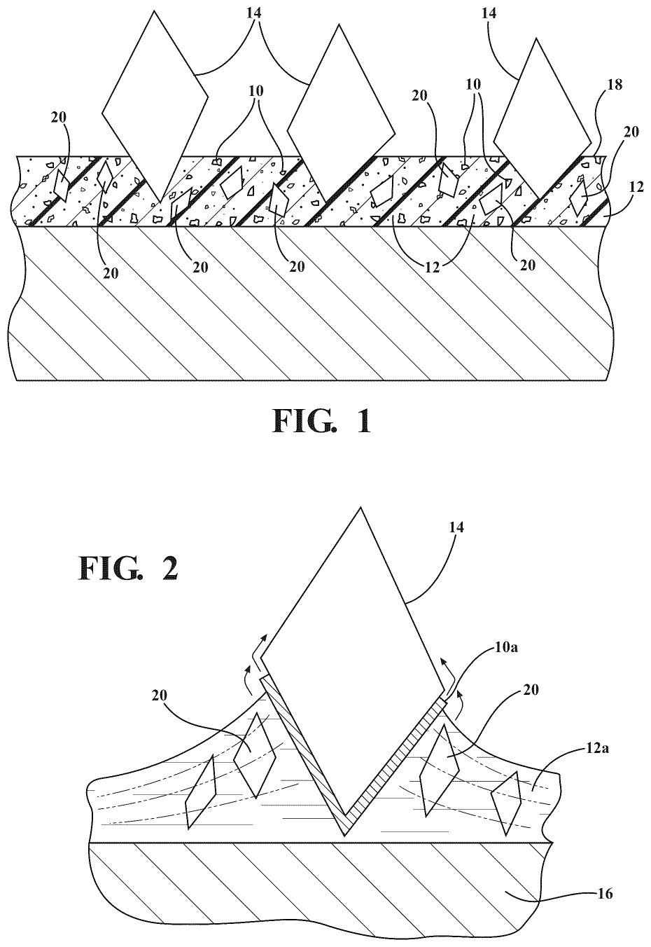

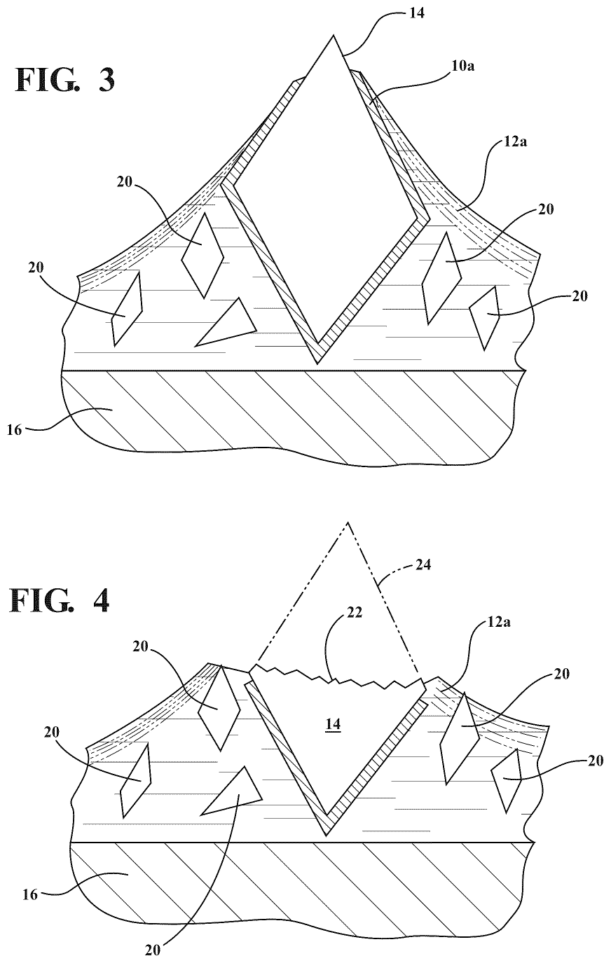

According to the fourth step of the present invention, the “green” tool, as shown in FIG. 1, with the layer of the coating mixture and diamond material is heated at an effective temperature to allow formation of an initial metal carbide layer 10a which is chemically bonded to the diamond surface. This ensures that the braze has a compatible metal carbide surface coating on which to attach to the diamond. In the preferred embodiment the heating step is accomplished in a vacuum of about 10⁻⁴ torr. However, the method of the present invention may be practiced in hydrogen containing atmospheres or in substantially reducing atmospheres with good results.

While not wishing to be bound by any particular theory, it is believed that initially the diamond is in contact with at least some of the metal carbide forming substance or comes into contact with carbide forming metals during flow of the molten braze solution which includes the carbide forming metals in the molten solution. Upon heating to an effective temperature, a metal carbide layer 10a begins to form on the diamond from the carbide forming substance immediately adjacent to the graphitized diamond surface. Thereafter, the molten braze 12a has an appropriate place to form a metallurgical bond with the diamond.

The reaction taking place in the present invention proceeds in a quasi-capillary manner up along the or even to entirely cover the diamond with a braze layer if desired. It is believed that this phenomenon occurs by the initial formation of the carbide layer after which the braze attaches allowing more of the carbide forming substance to come into contact and chemically bond to the diamond surface forming another suitable location for brazing to attach. In this manner the brazing metal is drawn up the side of the diamond particles in a quasi-capillary manner to the desired level. The height of the braze layer may be controlled by varying the time of the heating step.

Thus, during the heating step, the diamond can be heated to a temperature sufficient to cause free carbon atoms at the diamond surface and to form the desired metal carbide coating from the localized carbide forming metal. Formations of the metal carbide facilitates wetting of the diamond surface by the braze metal. The time and temperature of the heating step is determined by the particular carbide forming metal and braze composition chosen for use. Upper limits are determined by excessive graphitization or even complete breaking down of the diamond. Lower limits are functionally determined in that sufficient heating must be maintained to form the metal carbides and to melt the braze composition. Additionally, time and temperature may be utilized to control the amount of coverage of the diamond surface by the braze and the amount of filleting which is desired about the diamond particles.

As stated above, the braze is selected to be compatible, i.e., to alloy with the metal carbide on the diamond surface. Thus, good wetting of the diamond carbide interface is achieved and a strong braze bond is obtained. Suitable brazing processes useful in the present invention are set forth in the inventors U.S. Pat. No. 4,776,862 (issued Oct. 11, 1988 entitled “Brazing of Diamond”) and 4,968,326 (issued Nov. 6, 1990 entitled “Method of Brazing of Diamond to Substrate”) the disclosures of which is incorporated herein by reference thereto.

### EXAMPLE 1

An abrasive wheel is made by using a peripheral grinding wheel substrate.

For the brazing of a peripheral diamond grinding wheel, a steel core of 6.00″ diameter and 0.625″ thick is used. The 0.625″ surface was coated by brushing on a paste consisting of Wall Colmonoy “S” cement and a mixture of Wall Colmonoy Nicrobraze.® #10 Fe andMo in the following weight percents: Nicrobraze #10 86% (P=10%, C=0.06% BAL.=NI) Fe(−325 Mesh, Hydrogen 3.2% Reduced) Mo(6-12 Micron) 10.8% (20) While the paste is still wet, a primary grit comprising 50 grit diamond grit is sprinkled onto the paste along with a secondary protective 200 grit diamond. The coated core was allowed to air dry. The coated core was placed in a vacuum furnace that was computer controlled to carefully control the heat up and cool down cycle. The core and diamond mixture was heated to 1745.degree. F. at 10⁻⁴ torr and heated for 45 seconds. The results were a diamond wheel suitable for bevel edging CR-39 plastic ophthalmic lenses. The diamonds were found to be tenaciously held in the braze with about twenty five percent of the diamond exposed. The tool is used in its normal course for ophthalmic lens grinding and is found to be operable for over twice the life of a wheel having only the 80/100 diamond grit.

This example is repeated using primary diamond like hardness abrasives of from 5 microns to 1500 microns with from 0.1-9% by weight secondary protective abrasive grit which is 10% or less the size and as hard or harder than the primary abrasive grit. These tools are all found to provide substantially more useful life than tools without a secondary protective diamond like hardness abrasive grit material. The wheel is found to wear at least 20% better when used for grinding cast iron than a wheel without secondary protecting abrasive grit material.

### EXAMPLE 2

An abrasive wheel is made by using a peripheral grinding wheel substrate.

For the brazing of a peripheral diamond grinding wheel, a steel core of 6.00″ diameter and 0.625″ thick is used. The 0.625″ surface was coated by brushing on a paste consisting of Wall Colmonoy “S” cement and a mixture of Wall Colmonoy Nicrobraze.® #10 Fe and Mo in the following weight percents: Nicrobraze #10 86% (P=10%, C=0.06% BAL.=NI) Fe(−325 Mesh, Hydrogen 3.2% Reduced) Mo(6-12 Micron) 10.8% (20) While the paste is still wet, a primary grit comprising 80/100 grit diamond grit is sprinkled onto the paste along with a secondary protective 100/120 grit diamond. The coated core was allowed to air dry. The coated core was placed in a vacuum furnace that was computer controlled to carefully control the heat up and cool down cycle. The core and diamond mixture was heated to 1745.degree. F. at 10⁻⁴ torr and heated for 45 seconds. The results were a diamond wheel suitable for bevel edging CR-39 plastic ophthalmic lenses. The diamonds were found to be tenaciously held in the braze with about twenty five percent of the diamond exposed. The tool is used in its normal course for ophthalmic lens grinding and is found to be operable for over twice the life of a wheel having only the 80/100 diamond grit. The wheel is found to wear at least 20% better when used for grinding cast iron than a wheel without secondary abrasives.

This example is repeated using primary diamond like hardness abrasives of from 5 microns to 1500 microns with . . . 1, 2, 5,7 , 10, 12, 15, 30, 45, 55 and 60 % by weight secondary protective abrasive grit which is 10%, 20%, 30% 40% and 50% less in size or less the size and as hard or harder than the primary abrasive grit. These tools are all found to provide substantially more useful life than tools without a secondary protective diamond like hardness abrasive grit material. The wheel is found to wear at least 20% better when used for grinding cast iron than a wheel without secondary abrasives.

### EXAMPLE 3

(22) For the brazing of a cup type wheel used to generate the optical curvature in an ophthalmic lens, a 3½″ diameter with a 0.125″ radius face steel core is coated with a paste of Wall Colmonoy “S” cement and a mixture of Wall Colmonoy Nicrobraze.®. #10 with Fe and Mo in the weight percents as follows: Nicrobraze.200 #10 80% Fe (Same as in Example I) 10% MO (Same as in Example I) 10% 40/45 mesh diamond with was sprinkled onto the wheel core along with 0.1, 0.5, 2, 3, 5, 7 and 9% by weight of a secondary abrasive grit in sizes of from 10%-50% smaller sizes and 60/80 grit size is also used. This wheel is processed as in Example I except the heating step used was 1730.degree. F. at 10⁻⁴ torr for 45 seconds. The resultant tool is successfully used for grinding CR-39 ophthalmic lenses and is found to out last a like wheel without the secondary protective grit. The diamonds are found to be tenaciously held in the braze even after the tool is cycled for a time which normally would destroy a prior tool without having the secondary protective abrasive grit present.

### EXAMPLE 4

A router bit core made of steel is coated as in Example I with the following braze mixture constituent: Nicrobraze #130 80% (B=3.1%, Si=4.5% C=0.06% BAL.-Ni) Fe (Same as in Example I) 10% Mo (Same as in Example I) 10%

The coated router bit was furnaced at a temperature of 1900.degree. F. at 10⁻⁴ torr for 12 seconds. The resultant tool was very successful in the grinding of marble. The diamonds were tenaciously held in the braze (but to a lesser extent than in Examples I and II) with about seventy five percent exposure of the diamond surface This example is repeated using a secondary protective grit that has a grit sizes 4 microns to about 500 microns, using from about 0.5% to 5.0% by weight. The example is repeated using a grit size of from about 45 microns to about 350 microns using from about 1.0% to 4.0%. The example is repeated using a grit size of from about 74 microns to about 149 using 2.0% to 3.0% by weight.

Each of the resulting tools are found to perform substantially better than a tool without the secondary protective abrasive grit, with the tool lasting at least ⅓ longer in normal use.

The description of the invention is merely exemplary in nature and, thus, variations that do not depart from the essense of the invention are intended to be within the scope of the invention. Such variations are not to be regarded as a departure from the spirit and scope of the invention.

What is claimed is:

1. A diamond grinding, cutting or drilling tool which includes at least a monolayer of a primary diamond or diamond-like hardness material and a wear resistant diamond braze material comprising: a first primary grinding sized grit affixed to a surface of said grinding, cutting or drilling tool by a flowable braze material capable of wetting and bonding to said first grinding sized grit of carbon containing diamond or diamond-like hardness material and wherein said flowable brazing material containing a secondary protecting sized diamond or diamond-like hardness grit material which protects the primary grit material and flowable braze material during grinding with the diamond grinding, cutting and/or drilling tool.

2. The tool of claim 1 wherein the primary grinding sized carbon containing diamond or diamond-like hardness material is a grinding, cutting and/or drilling is a first size of not greater than 1500 microns and wherein the secondary protective sized grit diamond or diamond-like hardness material is at least a 10% smaller size grit than said first size having a grit size of from about 4 microns to about 500 microns.

3. The tool of claim 2 wherein the amount of secondary protective sized grit is used in the braze in an amount of from about 0.1% to about 60% by weight of the braze material.

4. The tool of claim 2 wherein the amount of secondary protective sized grit is used in the braze in an amount of less than or equal to 10% by weight.

5. The tool of claim 4 wherein the size of secondary protective grit is used in a typical amount of from about 45 microns to about 350 microns.

6. The tool of claim 4 wherein the size of the secondary protective grit is used in a preferred amount of from about 74 microns to about 149 microns.

7. The tool of claim 1 wherein the secondary protective grit is used in a typical amount of from about 0.1 to about 9.0% by weight.

8. The tool of claim 1 wherein the secondary protective grit is used in a preferred amount of from about 1.0 to about 7.0% by weight.

9. The tool of claim 1 where in the secondary protective has a grit size from generally from about ⅘ microns to about 500 microns, using from about 0.5% to 5.0% by weight typically from about 45 microns to about 350 microns using from about 1.0% to 4.0% and preferably from about 74 microns to about 149 using 2.0% to 3.0% by weight.

10. A diamond grinding, cutting or drilling tool which includes at least a monolayer of a primary diamond or diamond-like hardness material and a wear resistant diamond braze material comprising: a first primary grinding sized grit of a size of not greater than 1500 microns affixed to a surface of said grinding, cutting or drilling tool by a flowable braze material capable of wetting and bonding to said first grinding sized grit of carbon containing diamond or diamond-like hardness material and wherein said flowable brazing material containing a secondary protecting sized diamond or diamond-like hardness grit material which protects the primary grit material and flowable braze material during grinding with the diamond grinding, cutting and/or drilling tool wherein the secondary protective grit is of a size 10%-50% smaller than the size of the primary grinding sized grit material selected from a grit size of rom about ⅘ microns to about 500 microns.

11. The tool of claim 10 wherein the amount of secondary protective sized grit is used in the braze in an amount of 2% to 60% by weight.

12. The tool of claim 10 wherein the size of secondary protective grit is used in a typical amount of from about 45 microns to about 350 microns.

13. The tool of claim 10 wherein the size of the secondary protective grit is used in a preferred amount of from about 74 microns to about 149 microns.

14. The tool of claim 10 wherein the secondary protective grit is used in a typical amount of from about 0.1 to about 9.0% by weight.

15. The tool of claim 10 wherein the secondary protective grit is used in a preferred amount of from about 1.0 to about 7.0% by weight.

16. The tool of claim 10 where in the secondary protective has a grit size of from 45 microns to about 350 microns using from about 1.0% to 4.0 of said grit in the brazed mixture.

17. The tool of claim 10 wherein the grit size of the secondary protective grit is from about 74 microns to about 149 microns using 2.0% to 3.0% by weight of said grit in the braze mixture.

18. A process for reducing wear in a brazed diamond abrasive tool comprising the steps of:
A. Providing an abrasive grit substrate for attaching of a predetermined size primary abrasive grit material to the substrate with a suitable braze material;
B. Armoring the braze material with a secondary protective smaller sized diamond-like hardness abrasive grit material by adding to the brazing material a predetermined quantity of said secondary protective smaller sized abrasive grit material;
C. Brazing the predetermined size primary diamond or diamond like hardness material onto the abrasive grit substrate with the braze mixture containing the secondary protective smaller sized abrasive grit material for making and abrasive grit tool;
D. Abrading a substrate with the abrasive grit tool wherein the primary abrasive grit and the braze material with the secondary protective grit are protected during grinding by the secondary abrasive grit when the grit contacts the substrate.

19. The process of claim 18 wherein the secondary protective grit has a hardness substantially the same or greater than the hardness of the primary abrasive grit material that it is protecting.

20. The process of claim 19 wherein the primary abrasive grit and the secondary protective abrasive grit are both diamond grit material or a diamond like hardness grit material.
